(19) United States
(12) Patent Application Publication
(10) Pub. No.: US 2013/0147596 A1
(43) Pub. Date: Jun. 13, 2013

(54) Reactor Device

(71) Applicant: Kenji Nakanoue, Tainai (JP)

(72) Inventor: Kenji Nakanoue, Tainai (JP)

(73) Assignee: Hitachi Industrial Equipment Systems Co., Ltd., Chiyoda-ku, Tokyo (JP)

(21) Appl. No.: 13/810,852

(22) PCT Filed: Jul. 6, 2011
(86) PCT No.: PCT/JP2011/065500

§ 371 Date: Feb. 25, 2013

(30) Foreign Application Priority Data
Jul. 20, 2010 (JP) 2010-163021

(51) Int. Cl. H01F 3/04

(52) U.S. Cl. CPC H01F 3/04
USPC 336/233

(57) ABSTRACT

A reactor device is provided with a yoke section incorporating an elliptical wire-wound iron core and an iron-core leg section having wire-wound iron cores stacked one on another. The reactor device may have significantly deteriorated magnetic properties due to an abnormal current caused by a magnetic flux developed in the leg section. The short circuit of the abnormal current is cut by providing a cut portion from the center of the end surface of a wire-wound iron core in the leg section to the outer shape thereof and then insulating the cut portion. Use is made of a fixture jig to maintain the shape of the iron core even after the iron core has been cut, and at a final stage, use is made of a band or tape for maintaining the shape. The band used for maintaining the shape is adapted to prevent a magnetic flux developed in the iron core from making one turn.

### TECHNICAL FIELD

The present invention relates to a reactor device employed as an L for smoothing in a power source device, and more particularly, to a reactor device using an amorphous.

### BACKGROUND

The amorphous (amorphous magnetic alloy) material with a low loss property, which is employed for forming an iron core of the reactor is more likely to have properties deteriorated through processing and less workability than the electromagnetic steel plate used as the iron core material. As the material becomes extremely brittle after annealing, it is difficult to be used for production of the iron core utilizing the low loss property of such material. Especially when using the amorphous material for forming a stacked iron core structure, it is required to have a plate thickness of 0.025 mm, and furthermore, a great deal of labor is needed to stack them so as not to cause crack. For these reasons, the stacked iron core formed of the amorphous material is rarely used.

Normally the stacked iron core structure as the wound iron core structure is often used for production of the iron core with medium or large capacity. Because of difficulty in production of the stacked iron core using the amorphous material, a great deal of labor and cost may be needed to manufacture the reactor with large capacity.

The method of producing toroidal iron cores and stacking those iron cores may be employed to enlarge the reactor device using the amorphous material while minimizing the stress exerted to the iron core. However, the method causes the problem that the magnetic flux developed in the leg portion iron core has insufficient insulation between layers of the amorphous thin band, and the resultant short circuit applies abnormal current to cancel the developed magnetic flux.

Related art for solving the problem has been disclosed in Patent Literatures 1 to 2. Patent Literature 1 proposes use of the amorphous magnetic alloy thin band for production of the block iron core. The silicon steel plate is roll inserted into an intermediate portion of the roll thickness of the roll of the thin band to divide the thin band layer. The block iron core is provided with a slit portion formed by cutting the divided thin band layers in a radial direction. The proposed method is intended to reduce the eddy current loss caused by division of the thin band layer with the silicon steel plate, and short circuit between the thin bands resulting from the burr generated upon formation of the slit portion.

According to Patent Literature 2, the amorphous alloy thin band is wound to form a ring-shaped stacked body having one point cut in a stacking direction. It is further wound to form a curved (spiral) slit defined by abutment parts of both ends of the cut portion. The ring-shaped stacked body is annealed, and the insulator is inserted into the slit so as not to form a closed circuit in a circumferential direction of the block iron core.

### PRIOR ART LITERATURE

### Patent Literature

### Patent Literature 1: Japanese Unexamined Utility Model Registration Application Publication No. 61-1823

### Patent Literature 2: Japanese Unexamined Patent Application Publication No. 04-345009

### SUMMARY OF THE INVENTION

### Problem to be Solved by the Invention

According to Patent Literature 1, many process steps have to be performed, for example, roll inserting the silicon steel plate into an intermediate portion of the roll thickness of the amorphous magnetic alloy thin band, annealing the iron core after the roll insertion, radiating heat after the annealing, impregnating a resin thereafter, curing the resin, and forming the slit through machining. A long time is required for performing operations such as roll insertion of the silicon steel plate into the intermediate portion of the amorphous magnetic alloy thin band, heat radiation after the annealing, impregnation of the resin, and curing of the resin. Furthermore, the residual stress remains in connection with curing of the resin and formation of the slit, which may cause the risk of deteriorating magnetic properties.

According to Patent Literature 2, significant man-hours may be required for formation of the ring-shaped stacked body by cutting the wound iron core, and forming the curved (spiral) slit defined by abutment parts of both ends of the cut portion after further winding. The insulating paper is inserted into the slit portion that spirally extends from inner side to the outer side of the iron core after the annealing. It is difficult to perform the operation, and may cause the risk of increasing an amount of breakdown of the amorphous after the annealing upon insertion.

In view of the problem of the above-described related art, the present invention provides a reactor device that needs less manufacturing man-hours while suppressing the residual stress of the iron core caused by machine processing as low as possible.

### Means for Solving the Problem

In order to solve the aforementioned problem, the present invention provides a reactor device that includes a plurality of leg portion iron cores, and yoke section iron cores which are arranged at both ends of the leg portion iron cores. The leg portion iron core is formed of an amorphous metal wound iron core which has an insertion hole that penetrates through the center, and a slit formed along a radial direction. The yoke section iron core is formed of a wound iron core which has a substantially oval shape and a long hole communicated with the insertion hole of the leg portion iron core.

In the reactor device as described above, the leg portion iron core is subjected to processes of forming the slit and annealing while having the wound iron core fixed to iron core fixture jigs.

In the reactor device as described above, an insulator is inserted into the slit after the process of annealing in a state where the wound iron core of the leg portion iron core is fixed to the iron core fixture jigs.

In the reactor device as described above, the iron core fixture jig has an operation space at a position corresponding to the slit.

The reactor device as described above further includes a stud which is inserted into the insertion hole of the leg portion iron core and the long hole of the yoke section iron core. The stud serves to connect the leg portion iron core and the yoke section iron core.

### Advantage of the Invention

According to the present invention, the man-hour may be significantly reduced and breakage of the amorphous metal may also be decreased without deteriorating the magnetic properties of the iron core of the reactor device.

### BRIEF DESCRIPTION OF THE DRAWINGS

FIG. 1 shows a structure of an assembled iron core of the reactor device according to an embodiment of the present invention.

FIG. 2 is a plan view of an original shape of a yoke section iron core according to the embodiment.

FIG. 3 is a plan view of the yoke section iron core after forming according to the embodiment.

FIG. 4 is a perspective view of the leg portion iron core before formation of a slit according to the embodiment.

FIG. 5 is an explanatory view representing that the leg portion iron core is fitted with iron core fixture jigs.

FIG. 6 is an explanatory view representing machine processing of the slit in the leg portion iron core in the fixture jigs.

FIG. 7 is a perspective view of an insulator inserted into the slit of the leg portion iron core.

FIG. 8 is an exploded perspective view of the insulator.

FIG. 9 is a perspective view of the leg portion iron core into which the insulator is inserted.

FIG. 10 is a perspective view of the leg portion iron core fixed with a band.

FIG. 11 is an explanatory view representing an insulation portion of the band used for fixation.

### MODE FOR CARRYING OUT THE INVENTION

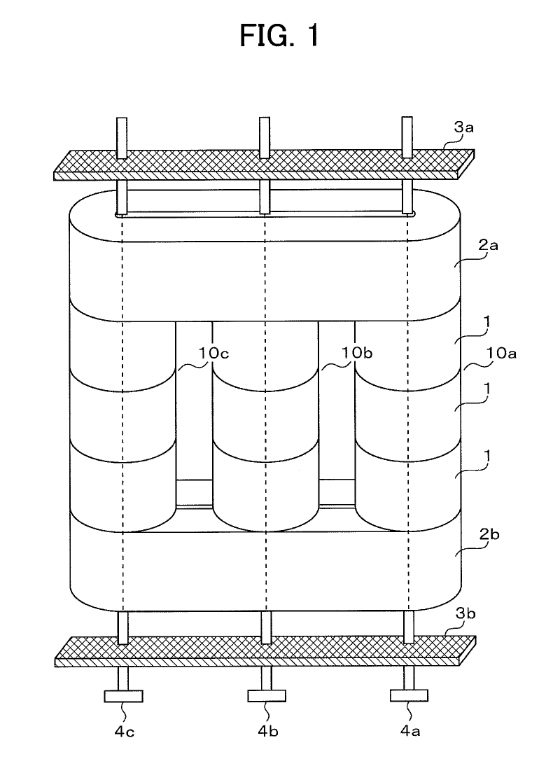

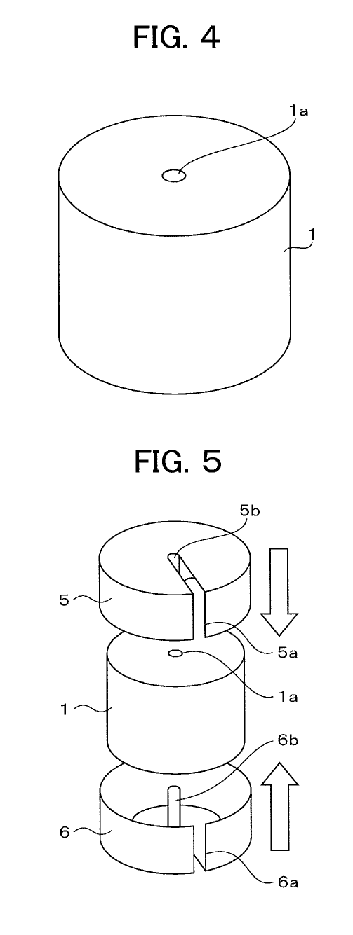

An embodiment according to the present invention will be described. FIG. 1 shows a structure of an assembled iron core of a reactor device. The iron core of the reactor device includes leg portion iron cores 10 (10a, 10b, 10c), and yoke section iron cores 2 (2a, 2b) arranged at upper and lower ends of the leg portion iron cores. The leg portion iron core 10 is formed by stacking a plurality of ring-shaped core units 1 one on another in a magnetizing direction. The core unit 1 is formed of an amorphous metal. The core unit has a toroidal shape formed by sequentially winding the amorphous metal as shown in FIG. 4. An insertion hole la with a small diameter is formed in an innermost circumference so as to allow passage of a stud for tightening.

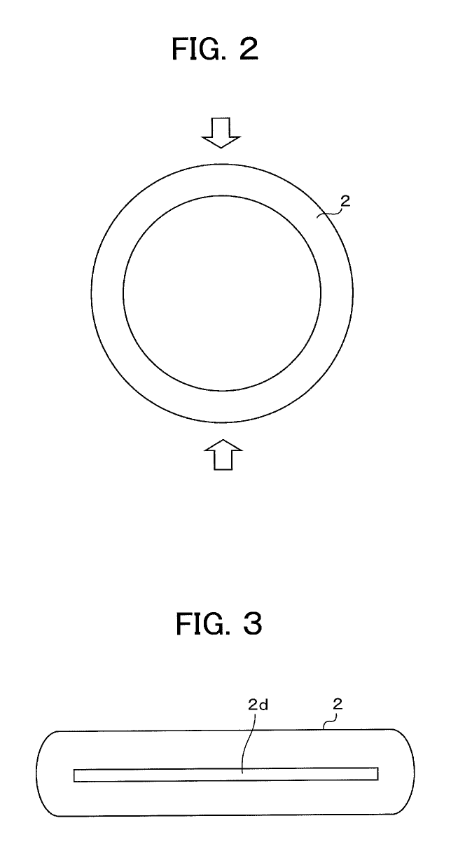

The yoke section iron core 2 is formed to have the toroidal shape by sequentially winding the amorphous metal so as to have an inner circumference with large diameter as shown in FIG. 2. It is formed to have substantially an oval shape through deformation in arrow directions as shown in FIG. 3. Simultaneously, the inner circumference with large diameter becomes a long hole 2d as a result of deformation so as to allow passage of the stud for tightening. Each of the substantially oval shape and the long hole is deformed to apply corner roundness in order to prevent crack of the amorphous metal. The insulator may be inserted into a part of the long hole 2d other than the one through which the stud passes. The yoke section iron cores 2 are arranged at upper and lower ends of the leg portion iron cores 10, and are integrally fixed to the leg portion iron cores 10 through the tightening plates 3 (3a, 3b) which are opposite the respective outer sides using the studs 4 (4a, 4b, 4c) so as to form the iron core for the reactor device. Each of the leg portion iron cores 10 and the yoke section iron cores 2 is formed of the same material with the same permeability so that the linking of the magnetic flux is smoothened, thus preventing deterioration in magnetic properties.

The ring-shaped core unit 1 of the leg portion iron core 10 will be described in more details. Referring to FIG. 4, the toroidal core unit 1 is prepared by sequentially winding the amorphous metal. Then as shown in FIG. 5, the toroidal core unit 1 is interposed and fixed between upper and lower iron core fixture jigs 5 and 6 so as to be covered in arrow directions. The iron core fixture jig 5 has a hollow cylindrical structure that opens downward, and the iron core fixture jig 6 has a hollow cylindrical structure that opens outward. Shafts 5b and 6b which are fitted with the insertion hole 1a of the toroidal core unit 1 are provided at the respective inner centers, and extend therefrom, respectively. The iron core fixture jigs 5 and 6 include operation spaces (radial openings) 5a and 6a each having a radial opening for cutting the cut portion (slit) in the radial direction, respectively.

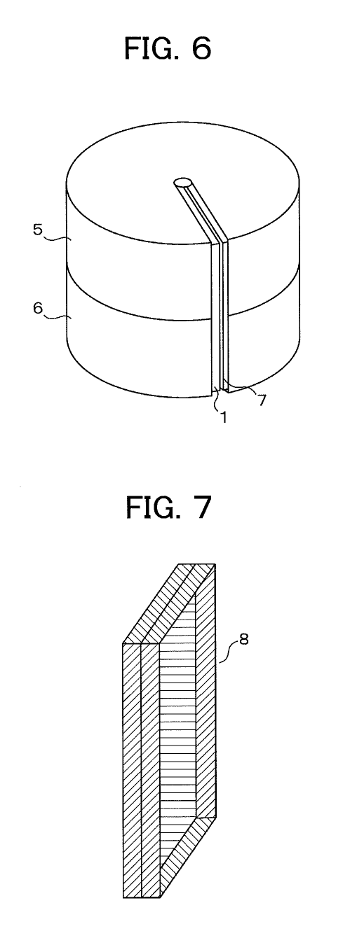

The iron core fixture jigs 5 and 6 serve to align the operation spaces 5a and 6a, and a machining tool is inserted into the respective operation spaces 5a and 6a while keeping the toroidal core unit 1 covered and fixed in the arrow directions as shown in FIG. 5 so as to perform machine processing the toroidal core unit 1 to form the slit 7 in the radial direction (see FIG. 6). Upon the machining process, the area adjacent to the slit to be machined is restrained by the iron core fixture jigs 5 and 6, and accordingly, the amorphous metal is not largely deflected, resulting in less breakage and improved processing accuracy. Even if the burr is generated upon the machine processing, the finished portion is restrained and aligned, which makes the operation easy. It is also an object of the invention to temporarily hold the core unit shape after machine processing the slit 7 in the toroidal core unit 1. It is therefore preferable to reduce the difference between the inner diameter of the jig and the outer diameter of the toroidal unit 1 as much as possible.

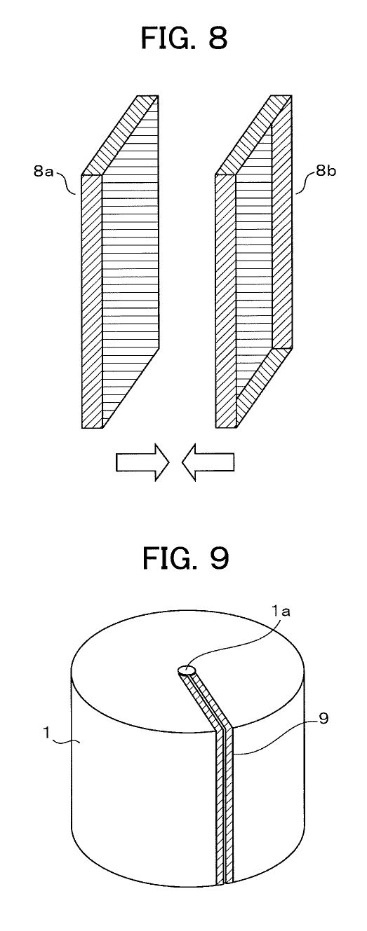

Referring to FIG. 6, after forming the slit 7, the core unit 1 is annealed in the magnetic field while being fixed to the iron core fixture jigs 5 and 6. Then an insulator 8 is inserted into the slit 7 so as to prevent the core unit 1 from causing the short circuit of one turn. The insulator 8 is formed by bonding two sheets of insulators 8a and 8b as shown in FIG. 8, which is then formed to have a T-shaped cross-section. Upon insertion, the T-shaped lower end is straightly folded out to extend downward, so as to be inserted into the slit 7 from above as shown in FIG. 6. After the insertion, the lower end is folded back so as to be bonded to the bottom surface of the core unit 1. Alternatively, NORMEX® tape or the like is directly inserted into the slit 7 as shown in FIG. 9 so as to be bonded. The aforementioned insulator is inserted in the state where the iron core 1 is fixed to the iron core fixture jigs 5 and 6. This ensures easy operation and reduction of the iron core breakage.

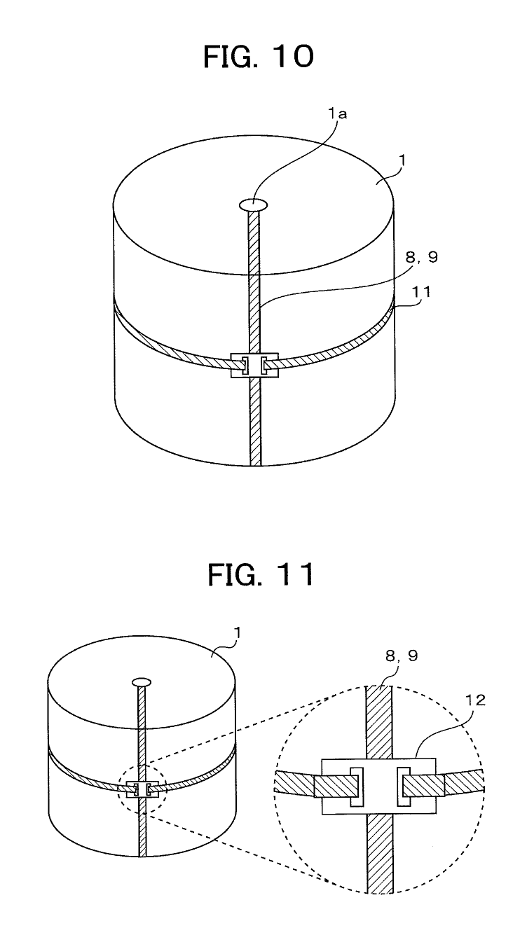

Any one of the iron core fixture jigs is removed from the iron core 1, and an outer circumference of the toroidal core unit 1 is tightened with an insulator band or an insulator tape 11 for fixation as shown in FIG. 10. Then the other iron core fixture jig is removed, and fixation is performed using another band or tape as well if necessary. The insulator band or the insulator tape 11 has an insulator 12 so as not to cause the short circuit of one turn with respect to the magnetic flux developed in the core unit 1.

The core unit 1 of the leg portion iron core 10 is structured as described above. A plurality of those core units are stacked one on another to form the leg portion iron core 10 (10a, 10b, 10c) as shown in FIG. 1.

As described above, upon production of the core unit 1 of the leg portion iron core, the slit is formed and the insulator is inserted without using the adhesive agent and varnish in the state where the core unit 1 is fixed to the iron core fixture jigs, resulting in reduced man-hours and high working efficiency. Furthermore, there is substantially no residual stress and no risk of deteriorating the magnetic properties, resulting in little chance of breaking the amorphous metal. This ensures easy operation for tightening and fixing the core unit 1 using the insulator band and the insulator tape 11.

The leg portion iron core and the yoke section iron core may be assembled through integral fixing by allowing passage of the stud through the insertion holes and long holes of both iron cores, resulting in improved working efficiency.

### DESCRIPTION OF CODES

1 . . . core unit, 1a . . . insertion hole, 2 (2a,2b) . . . yoke section iron core, 2d . . . long hole, 3 . . . tightening plate, 4 (4a,4b,4c) . . . stud, 5,6 . . . iron core fixture jig, 5a,6a . . .operation space, 5b,6b . . . shaft, 7 . . . slit, 8 (8a,8b),9 . . . insulator, 10 (10a,10b,10c) . . . leg portion iron core, 11 . . . insulator band, insulator tape, 12 . . . insulator

1. A reactor device provided with a plurality of leg portion iron cores, and yoke section iron cores which are arranged at both ends of the leg portion iron cores, wherein:
the leg portion iron core is formed of an amorphous metal wound iron core which has an insertion hole that penetrates through the center, and a slit formed along a radial direction; and
the yoke section iron core is formed of a wound iron core which has a substantially oval shape and a long hole communicated with the insertion hole of the leg portion iron core.

2. The reactor device according to claim 1, wherein the leg portion iron core is subjected to processes of forming the slit and annealing while having the wound iron core fixed to iron core fixture jigs.

3. The reactor device according to claim 2, wherein an insulator is inserted into the slit after the process of annealing in a state where the wound iron core of the leg portion iron core is fixed to the iron core fixture jigs.

4. The reactor device according to claim 2, wherein the iron core fixture jig has an operation space at a position corresponding to the slit.

5. The reactor device according to claim 1, further comprising a stud which is inserted into the insertion hole of the leg portion iron core and the long hole of the yoke section iron core, wherein the stud serves to connect the leg portion iron core and the yoke section iron core.

6. The reactor device according to claim 3, wherein the iron core fixture jig has an operation space at a position corresponding to the slit.

7. The reactor device according to claim 2, further comprising a stud which is inserted into the insertion hole of the leg portion iron core and the long hole of the yoke section iron core, wherein the stud serves to connect the leg portion iron core and the yoke section iron core.

8. The reactor device according to claim 3, further comprising a stud which is inserted into the insertion hole of the leg portion iron core and the long hole of the yoke section iron core, wherein the stud serves to connect the leg portion iron core and the yoke section iron core.

9. The reactor device according to claim 4, further comprising a stud which is inserted into the insertion hole of the leg portion iron core and the long hole of the yoke section iron core, wherein the stud serves to connect the leg portion iron core and the yoke section iron core.

10. The reactor device according to claim 6, further comprising a stud which is inserted into the insertion hole of the leg portion iron core and the long hole of the yoke section iron core, wherein the stud serves to connect the leg portion iron core and the yoke section iron core.
